(19) United States
(12) Patent Application Publication
(10) Pub. No.: US 2026/0135024 A1
(43) Pub. Date: May 14, 2026

(54) SUPERCONDUCTING MAGNET DEVICE

(71) Applicant: SUMITOMO HEAVY INDUSTRIES, LTD., Tokyo (JP)

(72) Inventor: Yuta EBARA, Yokosuka-shi (JP)

(21) Appl. No.: 19/444,028

(22) Filed: Jan. 8, 2026

Related U.S. Application Data
(63) Continuation of application No. PCT/JP2024/029927, filed on Aug. 23, 2024.

(30) Foreign Application Priority Data
Sep. 5, 2023 (JP) 2023-143496

(51) Int. Cl. H01F 6/02; H01F 6/04; H01F 6/06

(52) U.S. Cl. CPC H01F 6/02; H01F 6/04; H01F 6/06

(57) ABSTRACT

A superconducting magnet device includes a primary circuit including a superconducting coil and a primary-side resistor connected to the superconducting coil, and a secondary circuit including a secondary coil electromagnetically coupled to the superconducting coil and a secondary-side resistor connected to the secondary coil, in which a time constant of the secondary circuit is equal to or more than a time constant of the primary circuit.

### CROSS-REFERENCE TO RELATED APPLICATIONS

This is a bypass continuation of International PCT Application No. PCT/JP2024/029927, filed on Aug. 23, 2024, which claims priority to Japanese Patent Application No. 2023-143496, filed on Sep. 5, 2023, which are incorporated by reference herein in their entirety.

### BACKGROUND

### Technical Field

A certain embodiment of the present invention relates to a superconducting magnet device.

### Description of Related Art

An undesirable phenomenon that may occur during an operation of a superconducting magnet device is thermal runaway (quench) of a superconducting coil. When a quench occurs, the superconducting coil transitions from superconductivity to normal conductivity, and resistance is generated inside the coil. A large current flowing through the coil in the superconducting state can cause a large amount of Joule heat. There may also be a voltage rise in the coil and a resulting discharge. In addition, an imbalance of a transient current when the quench occurs may cause a large electromagnetic force to act on the superconducting coil. An eddy current may also be generated in a conductor disposed in the vicinity of the coil, causing an electromagnetic force to act. The heat, discharge, and electromagnetic forces that can be generated in this way may damage the superconducting coil and surrounding structures and devices. Therefore, it has been proposed to provide an induction coil near the superconducting coil. When a quench occurs, energy can be recovered from the superconducting coil to the induction coil through electromagnetic induction, allowing the energy held by the superconducting coil to be released.

### SUMMARY

One or more embodiments provide a superconducting magnet device including a primary circuit including a superconducting coil and a primary-side resistor connected to the superconducting coil, and a secondary circuit including a secondary coil electromagnetically coupled to the superconducting coil and a secondary-side resistor connected to the secondary coil. A time constant of the secondary circuit is equal to or more than a time constant of the primary circuit.

### BRIEF DESCRIPTION OF THE DRAWINGS

FIG. 1 is a diagram schematically showing a superconducting magnet device, according to an embodiment.

FIG. 2 is a graph showing a relationship between a time constant ratio and an energy extraction efficiency, and it has been recognized that the relationship is based on analysis, according to the embodiment.

FIG. 3 is a graph showing a relationship between a coupling coefficient and the energy extraction efficiency based on analysis by the present inventors, according to the embodiment.

FIG. 4 is a diagram schematically showing a superconducting magnet device, according to another embodiment.

FIGS. 5A and 5B are diagrams schematically showing the superconducting magnet device, according to other embodiments.

FIG. 6 is a diagram schematically showing another example of the superconducting magnet device, according to the embodiment.

### DETAILED DESCRIPTION

Since the temperature of the superconducting coil in which the quench has occurred is increased by the joule heat, the superconducting coil needs to be re-cooled for recovery. As the amount of energy recovered from the superconducting coil when a quench occurs is larger, the temperature rise of the superconducting coil is suppressed, and the time required for re-cooling the superconducting coil, that is, the recovery can be shortened.

According to the present invention, it is possible to efficiently recover energy from the superconducting coil.

Hereinafter, an embodiment for implementing the present invention will be described in detail with reference to the drawings. In the description and the drawings, the same or equivalent components, members, and processes are denoted by the same reference numerals, and overlapping description is omitted as appropriate. The scale or shape of each part that is shown in the drawings is conveniently set for ease of description and is not limitedly interpreted unless otherwise specified. The embodiment is merely an example and does not limit the scope of the present invention in any way. All features or combinations thereof described in the embodiments are not necessarily essential to the invention.

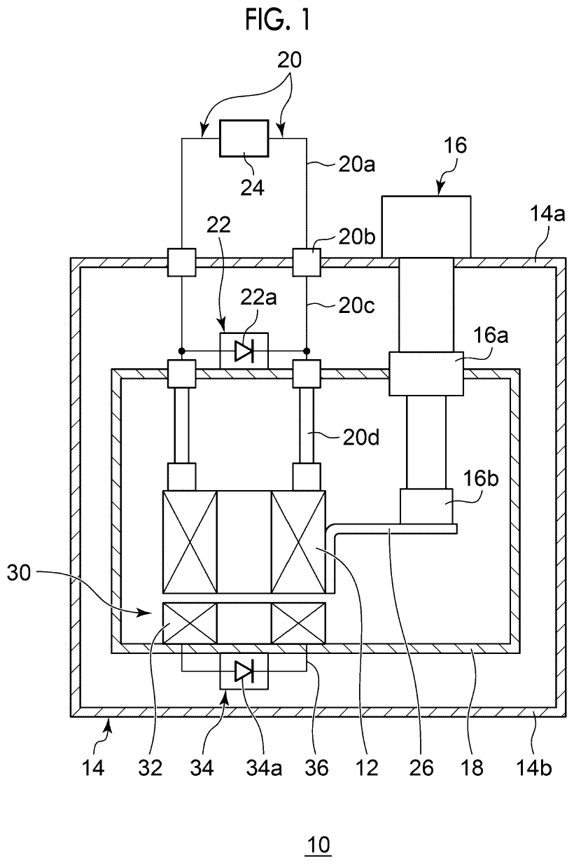

FIG. 1 is a diagram schematically showing a superconducting magnet device 10 according to an embodiment. The superconducting magnet device 10 can be mounted on a high-magnetic field utilization device as a magnetic field source of, for example, a single crystal pulling device, a nuclear magnetic resonance (NMR) system, a magnetic resonance imaging (MRI) system, an accelerator such as a cyclotron, a high energy physics system such as a nuclear fusion system, or other high-magnetic field utilization devices (not shown) and can generate a high magnetic field required for the device.

The superconducting magnet device 10 includes a superconducting coil 12, a vacuum vessel 14, a cryocooler 16, a heat shield 18, a current introduction line 20, a first Joule heat generating element 22, and an energy extraction mechanism 30 including a secondary coil 32 and a second Joule heat generating element 34.

The superconducting coil 12 is disposed in the vacuum vessel 14, and is configured to generate a strong magnetic field by being energized in a state of being cooled to a cryogenic temperature equal to or lower than a superconducting transition temperature. The superconducting coil 12 may be, for example, a so-called low-temperature superconducting coil or another known superconducting coil. The superconducting coil 12 is connected to an external power source 24 disposed outside the vacuum vessel 14 by a current introduction line 20. An excitation current is supplied from the external power source 24 to the superconducting coil 12 through the current introduction line 20. Accordingly, the superconducting magnet device 10 can generate a strong magnetic field.

The vacuum vessel 14 is an adiabatic vacuum vessel that provides a cryogenic vacuum environment suitable for bringing the superconducting coil 12 into a superconducting state, and is also called a cryostat. In general, the vacuum vessel 14 has a columnar shape or a cylindrical shape with a hollow portion at a center portion thereof. Therefore, in a case where the vacuum vessel 14 has a columnar shape, the vacuum vessel 14 has a generally flat circular top plate 14a and a bottom plate 14b and a cylindrical outer peripheral wall connecting the top plate 14a and the bottom plate 14b. In a case where the vacuum vessel 14 has a cylindrical shape, the vacuum vessel 14 has a generally flat annular top plate 14a and a bottom plate 14b and a cylindrical outer peripheral wall and an inner peripheral wall coaxially disposed to connect the top plate 14a and the bottom plate 14b. As an example, the cryocooler 16 may be installed on the top plate 14a of the vacuum vessel 14. The vacuum vessel 14 is formed of, for example, a metal material such as stainless steel or another suitable high-strength material to withstand a surrounding pressure. The surrounding pressure may be, for example, atmospheric pressure.

The cryocooler 16 is configured to cool the heat shield 18 and the first Joule heat generating element 22 to a first cooling temperature and to cool the superconducting coil 12 to a second cooling temperature lower than the first cooling temperature. In this embodiment, the cryocooler 16 is a two-stage Gifford-McMahon (GM) cryocooler and includes a first cooling stage 16a and a second cooling stage 16b. The first cooling stage 16a and the second cooling stage 16b are provided to surround a first expansion space and a second expansion space in the cryocooler 16, respectively, and are formed of, for example, a metal material such as copper or other materials having high thermal conductivity. The first cooling temperature may be in a temperature range of about 20 K to about 100 K, for example, in a temperature range of about 30 K to about 50 K, and the second cooling temperature may be in a temperature range of about 3 K to about 20 K, for example, about 4 K.

The heat shield 18 is disposed to surround the superconducting coil 12 within the vacuum vessel 14. The heat shield 18 is formed of, for example, a metal material such as copper or other materials having high thermal conductivity. The heat shield 18 is directly attached to the first cooling stage 16a of the cryocooler 16 and is thermally coupled to the first cooling stage 16a. Alternatively, the heat shield 18 may be attached to the first cooling stage 16a via a heat transfer member having flexibility or rigidity. During an operation of the superconducting magnet device 10, the heat shield 18 is cooled to the first cooling temperature by the first cooling stage 16a. The heat shield 18 can thermally protect low-temperature sections such as the second cooling stage 16b of the cryocooler 16 and the superconducting coil 12, which are disposed inside the heat shield 18 and are cooled to a lower temperature than the heat shield 18, from radiant heat from the vacuum vessel 14.

The superconducting coil 12 is thermally coupled to the second cooling stage 16b via a heat transfer member 26. The heat transfer member 26 is formed of a metal material such as copper or other materials having high thermal conductivity, and connects the superconducting coil 12 to the second cooling stage 16b. The heat transfer member 26 may be a rigid member rigidly connecting the superconducting coil 12 and the second cooling stage 16b, or may have flexibility and connect the superconducting coil 12 and the second cooling stage 16b to each other to allow relative displacement therebetween. Alternatively, the superconducting coil 12 may be directly attached to the second cooling stage 16b and may be thermally coupled to the second cooling stage 16b. During the operation of the superconducting magnet device 10, the superconducting coil 12 is cooled to the second cooling temperature by the second cooling stage 16b.

The current introduction line 20 includes an external wiring line 20a, a feedthrough 20b, an outer current lead 20c, and an inner current lead 20d, and forms a current path from the external power source 24 to the superconducting coil 12. Typically, one current introduction line 20 on a positive electrode side and one current introduction line 20 on a negative electrode side are provided.

The external wiring line 20a disposed outside the vacuum vessel 14 connects the external power source 24 to the feedthrough 20b provided in a wall portion of the vacuum vessel 14. The external wiring line 20a may be a suitable power supply cable. The feedthrough 20b is a hermetically sealed terminal for introducing a current into the vacuum vessel 14, and connects the external wiring line 20a to an internal wiring line in the vacuum vessel 14, that is, the outer current lead 20c and the inner current lead 20d. The current introduction line 20 can penetrate the wall portion of the vacuum vessel 14 while maintaining airtightness of the vacuum vessel 14 using the feedthrough 20b.

The outer current lead 20c is disposed outside the heat shield 18 in the vacuum vessel 14 and connects the feedthrough 20b to the inner current lead 20d. The outer current lead 20c is formed of, for example, a metal material having excellent conductivity, such as pure copper represented by oxygen-free copper. A terminal of the outer current lead 20c connected to the inner current lead 20d is thermally coupled to the heat shield 18 and is cooled to the first cooling temperature by the first cooling stage 16a.

The inner current lead 20d is disposed inside the heat shield 18 and connects the outer current lead 20c to the superconducting coil 12. A first end of the inner current lead 20d connected to the outer current lead 20c is thermally coupled to the heat shield 18 and is cooled to the first cooling temperature in the same manner as the heat shield 18. A second end of the inner current lead 20d connected to the superconducting coil 12 is cooled to the second cooling temperature in the same manner as the superconducting coil 12.

The inner current lead 20d may include a high-temperature superconducting current lead that connects the first end and the second end. The high-temperature superconducting current lead may be formed of, for example, a copper oxide superconductor or other high-temperature superconducting materials. The material of such a high-temperature superconducting current lead has heat insulating properties. Therefore, compared to a case where the inner current lead 20d is made of a metal, it is possible to reduce heat that can be transferred from the first Joule heat generating element 22 to the superconducting coil 12 through the inner current lead 20d as a heat transfer path. This can reduce a thermal load on the second cooling stage 16b of the cryocooler 16 and can contribute to better cooling of the superconducting coil 12.

The first Joule heat generating element 22 can generate heat when energized, and may include a general linear (that is, Ohmic) resistive element or may include a nonlinear resistor. In this embodiment, the first Joule heat generating element 22 includes, as an example, a first diode 22a. The first Joule heat generating element 22 is connected in parallel to the superconducting coil 12. The first Joule heat generating element 22 has one end connected to the current introduction line 20 on the positive electrode side and the other end connected to the current introduction line 20 on the negative electrode side, and is thereby connected in parallel to the superconducting coil 12.

In this embodiment, the first Joule heat generating element 22 is cooled to a higher cooling temperature than the superconducting coil 12 during an operation of the superconducting coil 12. The first Joule heat generating element 22 may be thermally coupled to the first cooling stage 16a of the cryocooler 16 and cooled to the first cooling temperature. As in the example shown in the drawing, the first Joule heat generating element 22 may be connected between the outer current leads 20c and may be installed in, for example, a portion cooled to the first cooling temperature, such as the heat shield 18.

When a quench occurs during the operation of the superconducting coil 12, a voltage generated in the superconducting coil 12 is also applied to the first Joule heat generating element 22. In this case, a current can be caused to flow from the superconducting coil 12 to the first Joule heat generating element 22, and at least a portion of electromagnetic energy stored in the superconducting coil 12 can be converted into heat by the first Joule heat generating element 22 and consumed. In this way, by extracting energy from the superconducting coil 12 by the first Joule heat generating element 22, the superconducting coil 12 can be protected when a quench occurs. By reducing the energy of the superconducting coil 12, it is possible to prevent or reduce damage to the superconducting coil 12 and surroundings thereof that may arise as a result.

When a temperature rise of the superconducting coil 12 due to the quench is large, a time required for the recooling for restoration is extended, that is, a downtime of the superconducting magnet device 10 may increase. In this embodiment, the first Joule heat generating element 22 is cooled to a higher cooling temperature than the superconducting coil 12. Therefore, compared to an existing typical design in which such a quench protection circuit is cooled to the same temperature (that is, the second cooling temperature) as the superconducting coil, recooling can be accomplished in a shorter time. The time required to recover the superconducting magnet device 10 from the quench can be shortened.

Since the first Joule heat generating element 22 is cooled by the first cooling stage 16a of the cryocooler 16, the heat emitted by the first Joule heat generating element 22 can be efficiently removed. This is because a cooling capacity of a first stage of the cryocooler 16 is usually larger (for example, several tens of times larger) than a cooling capacity of a second stage, and there is a relatively large margin. This is also advantageous in shortening the time required to recover the superconducting magnet device 10 from the quench.

As an alternative, the first Joule heat generating element 22 may be cooled to the same temperature as the superconducting coil 12. That is, the first Joule heat generating element 22 may be thermally coupled to the second cooling stage 16b of the cryocooler 16 and cooled to the second cooling temperature. In this case, the first Joule heat generating element 22 may be connected between the inner current leads 20d and may be installed in a portion cooled to the second cooling temperature, such as the superconducting coil 12 and the heat transfer member 26. As a further alternative, the first Joule heat generating element 22 may be disposed in a surrounding environment outside the vacuum vessel 14. In this case, the first Joule heat generating element 22 may be connected between the external wiring lines 20a.

As described above, the energy extraction mechanism 30 includes the secondary coil 32 and the second Joule heat generating element 34. The secondary coil 32 is disposed adjacent to or near the superconducting coil 12 and is electromagnetically coupled to the superconducting coil 12. The secondary coil 32 may be a normal conduction coil formed of a conductor such as copper. The secondary coil 32 may be a coil formed by winding a conductive wire or may be a C-shaped ring formed of a conductive plate. The C-shaped ring can function as a coil having a number of turns of 1.

The secondary coil 32 is cooled to a higher cooling temperature than the superconducting coil 12 during the operation of the superconducting coil 12, as in the first Joule heat generating element 22. The secondary coil 32 may be thermally coupled to the first cooling stage 16a of the cryocooler 16 and cooled to the first cooling temperature. As in the example shown in the drawing, the secondary coil 32 may be installed in a portion cooled to the first cooling temperature, such as the heat shield 18.

The secondary coil 32 is disposed to face an end surface of the superconducting coil 12 with a gap therebetween. In the example shown in the drawing, the secondary coil 32 is disposed to face a lower end surface of the superconducting coil 12, but other disposition is also possible. The secondary coil 32 may be disposed to face an upper end surface, an outer peripheral surface, or an inner peripheral surface of the superconducting coil 12. The gap between the secondary coil 32 and the superconducting coil 12 may be determined to avoid thermal contact between the two.

The second Joule heat generating element 34 is connected between both ends of the secondary coil 32. The second Joule heat generating element 34 can generate heat when energized, and may include a general linear (that is, Ohmic) resistive element or may include a nonlinear resistor. In this embodiment, the second Joule heat generating element 34 includes, as an example, a second diode 34a.

The second Joule heat generating element 34 may be cooled to a higher cooling temperature than the superconducting coil 12 during the operation of the superconducting coil 12, as in the first Joule heat generating element 22. The second Joule heat generating element 34 may be thermally coupled to the first cooling stage 16a of the cryocooler 16 and cooled to the first cooling temperature. The second Joule heat generating element 34 may be installed in a portion cooled to the first cooling temperature, such as the heat shield 18.

As an alternative, the second Joule heat generating element 34 may be cooled to the same temperature as the superconducting coil 12. That is, the second Joule heat generating element 34 may be thermally coupled to the second cooling stage 16b of the cryocooler 16 and cooled to the second cooling temperature. As a further alternative, the second Joule heat generating element 34 may be disposed in a surrounding environment outside the vacuum vessel 14.

The nonlinear resistive element used as the first Joule heat generating element 22 or the second Joule heat generating element 34 may have nonlinear characteristics in which a resistance value is high when a voltage applied to the nonlinear resistor is low and the resistance value is low when the voltage applied to the nonlinear resistor is high. That is, the nonlinear resistor may have a first resistance value when the voltage applied to the nonlinear resistor is a first value, and may have a second resistance value smaller than the first resistance value when the voltage applied to the nonlinear resistor is a second value greater than the first value.

The nonlinear resistor may be, for example, a rectifying element such as a diode or a thyristor. Alternatively, the nonlinear resistor may be a varistor. At least one of the first Joule heat generating element 22 and the second Joule heat generating element 34 may include both a linear resistor and a nonlinear resistor, and for example, these may be connected in series.

The secondary coil 32 and the second Joule heat generating element 34 are connected by an electric wiring line 36. The electric wiring line 36 may be formed of a metal material such as copper or other conductive materials. Alternatively, the electric wiring line 36 may include a high-temperature superconducting current lead.

In general, when a quench or a sign of a quench is detected in the superconducting coil 12, the operation of the superconducting magnet device 10 is stopped, and the superconducting coil 12 is demagnetized. The magnetic field generated by the superconducting coil 12 is rapidly decreased from a desired high magnetic field to zero. In this case, a current is induced in the secondary coil 32 by electromagnetic induction. This current flows from the secondary coil 32 to the second Joule heat generating element 34 through the electric wiring line 36, and the second Joule heat generating element 34 generates heat. In this way, the electromagnetic energy stored in the superconducting coil 12 is electromagnetically extracted by the secondary coil 32 and is converted into heat by the second Joule heat generating element 34. The heat is removed by cooling with the cryocooler 16.

In this way, at least a portion of the energy of the superconducting coil 12 can be consumed by the energy extraction mechanism 30. By reducing the energy of the superconducting coil 12, it is possible to prevent or reduce damage to the superconducting coil and surroundings thereof that may arise as a result.

In addition, when a temperature rise of the superconducting coil 12 due to the quench is large, a time required for the recooling for restoration is extended, that is, a downtime of the superconducting magnet device 10 may increase. In this embodiment, the energy extraction mechanism 30 can extract energy from the superconducting coil 12, which is advantageous in that the temperature rise of the superconducting coil 12 can be suppressed, and the time required for restoration from a quench can be shortened.

Since the energy extraction mechanism 30 is cooled by the first cooling stage 16a of the cryocooler 16, the heat emitted by the energy extraction mechanism 30 can be efficiently removed. This is because, as described above, the cooling capacity of the first stage of the cryocooler 16 is generally larger (for example, several tens of times larger) than the cooling capacity of the second stage, and there is a relatively large margin. This is also advantageous in shortening the time required to recover the superconducting magnet device 10 from the quench.

The present inventors have found that a large time constant τ2 of the secondary circuit, that is, the energy extraction mechanism 30, in the superconducting magnet device 10 described above is advantageous for the energy extraction from the superconducting coil 12. The time constant τ2 of the secondary circuit is defined by a ratio L2/R2 of an inductance L2 of the secondary coil 32 to a resistance value R2 of a secondary-side resistor connected to the secondary coil 32. As the inductance L2 is larger, an induced electromotive force of the secondary coil 32 is larger, and as the resistance value R2 is smaller, a current value of the secondary coil 32 is larger. That is, the large time constant τ2 of the secondary circuit means that a large current can be caused to flow through the secondary coil 32. Therefore, the energy can be efficiently extracted from the superconducting coil 12 by the energy extraction mechanism 30.

In a case of determining the time constant τ2 of the secondary circuit, a resistance value of the second Joule heat generating element 34 is used as the resistance value R2 of the secondary-side resistor. In a case where the second Joule heat generating element 34 is a linear resistor, a constant resistance value thereof is used. In a case where the second Joule heat generating element 34 is a nonlinear resistor, such as the second diode 34a, a differential resistance value (dV2/dI2) can be used. V2 and I2 represent a voltage and a current applied to the second Joule heat generating element 34, respectively. In a case where the resistance value R2 of the secondary-side resistor changes as described above, a minimum value thereof may be used as a representative value to determine the time constant τ2 of the secondary circuit. In a case where the second Joule heat generating element 34 includes a plurality of resistive elements, for example, both the linear resistor and the nonlinear resistor, the secondary-side resistor is regarded as a composite resistance of the plurality of resistive elements.

As a criterion indicating that the time constant τ2 of the secondary circuit is large, a time constant τ1 of the primary circuit in the superconducting magnet device 10 can be used. Therefore, as will be described below, the time constant τ2 of the secondary circuit may be equal to or more than the time constant τ1 of the primary circuit. The primary circuit includes the superconducting coil 12 and a primary-side resistor connected to the superconducting coil 12. The time constant τ1 of the primary circuit is defined by a ratio L1 /R1 of an inductance L1 of the superconducting coil 12 to a resistance value R1 of the primary-side resistor.

In a case of determining the time constant τ1 of the primary circuit, a resistance value of a resistive element connected to the primary circuit, for example, a resistance value of the first Joule heat generating element 22, can be used as the resistance value R1 of the primary-side resistor. In a case where the first Joule heat generating element 22 is a linear resistor, a constant resistance value thereof is used. In a case where the first Joule heat generating element 22 is a nonlinear resistor, such as the first diode 22a, a differential resistance value (dV1/dI1) can be used. V1 and I1 represent a voltage and a current applied to the first Joule heat generating element 22, respectively. In a case where the resistance value R1 of the primary-side resistor changes as described above, a maximum value thereof may be used as a representative value to determine the time constant τ1 of the primary circuit. In a case where the first Joule heat generating element 22 includes a plurality of resistive elements, for example, both a linear resistor and a nonlinear resistor, the primary-side resistor is regarded as a composite resistance of the plurality of resistive elements. It should be noted that, where possible, not only the resistive element connected to the primary circuit but also other resistors included in the primary circuit, such as the resistor of the superconducting coil 12 during the quench and connection resistors, may be taken into consideration. That is, a composite resistance of these resistors may be used as the resistance value R1 of the primary-side resistor.

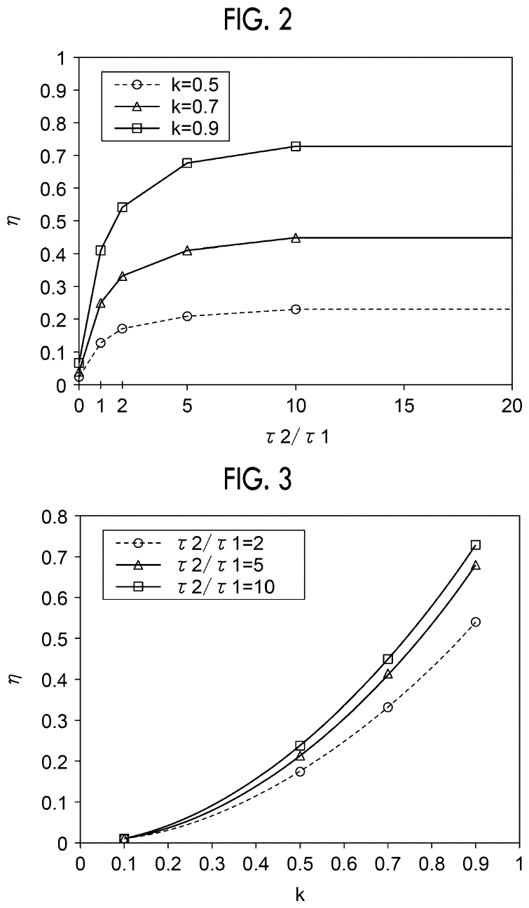

FIG. 2 is a graph showing a relationship between a time constant ratio τ2/τ1 and an energy extraction efficiency η based on analysis by the present inventors, according to the embodiment. In FIG. 2, a horizontal axis represents a ratio τ2/τ1 of the time constant τ2 of the secondary circuit to the time constant τ1 of the primary circuit, and a vertical axis represents the energy extraction efficiency η. The relationship between the time constant ratio τ2/τ1 and the energy extraction efficiency η is calculated for a plurality of values of a coupling coefficient κ between the superconducting coil 12 and the secondary coil 32, and these are shown in FIG. 2. Specifically, the relationship is shown for three cases in which the coupling coefficient κ is 0.5, 0.7, and 0.9.

Here, the energy extraction efficiency η is defined by a ratio E2/E1 of electromagnetic energy E2 extracted by the secondary coil 32 to electromagnetic energy E1 released from the superconducting coil 12 due to a quench. Therefore, a large value of the energy extraction efficiency η indicates that the energy is efficiently extracted from the superconducting coil 12 by the energy extraction mechanism 30.

As can be understood from FIG. 2, the energy extraction efficiency η monotonically increases as the time constant ratio τ2/τ1 increases. More specifically, the energy extraction efficiency η increases at a significant rate when the time constant ratio τ2/τ1 is smaller than a time constant ratio threshold value, for example, 1, and the rate of increase is reduced and the energy extraction efficiency η is saturated when the time constant ratio τ2/τ1 exceeds the threshold value. A change in the energy extraction efficiency η in response to the increase in the time constant ratio τ2/τ1 is common regardless of the magnitude of the coupling coefficient κ. However, the larger the coupling coefficient κ is, the larger the value of the energy extraction efficiency η is.

In practice, the energy extraction efficiency η by the energy extraction mechanism 30 is desirably at least 0.1. In order to realize this, the time constant ratio τ2/τ1 is preferably 1 or more. In other words, the time constant τ2 of the secondary circuit is preferably equal to or more than the time constant τ1 of the primary circuit. In order to realize a larger energy extraction efficiency η, the time constant τ2 of the secondary circuit may be 2 times or more, 5 times or more, or 10 times or more the time constant τ1 of the primary circuit. In addition, since the energy extraction efficiency η is saturated as the time constant ratio τ2/τ1 increases, the energy extraction efficiency η does not increase even in a case where the time constant ratio τ2/τ1 is excessively increased. Therefore, the time constant τ2 of the secondary circuit may be 20 times or less, 15 times or less, or 10 times or less the time constant τ1 of the primary circuit.

In this embodiment, as described above, the secondary coil 32 is cooled to the first cooling temperature by the cryocooler 16. By cooling the secondary coil 32 to a cryogenic temperature in this way, electrical resistivity of the secondary coil 32 can be reduced. Since the time constant τ2 of the secondary circuit is inversely proportional to the electrical resistivity of the secondary coil 32, the time constant τ2 of the secondary circuit can be increased.

In this embodiment, a case where the secondary coil 32 is the normal conduction coil is described as an example, but the secondary coil 32 may include a superconducting coil. In a case where the secondary coil 32 is cooled to the first cooling temperature, the secondary coil 32 may include a high-temperature superconducting coil. Since the superconducting coil can pass a large current, the energy can be efficiently extracted from the superconducting coil 12 by the secondary coil 32. In a case where the secondary coil 32 is cooled to the second cooling temperature, the secondary coil 32 may include a low-temperature superconducting coil. In addition, the secondary coil 32 may include both the normal conduction coil and the superconducting coil.

FIG. 3 is a graph showing a relationship between the coupling coefficient κ and the energy extraction efficiency η based on analysis by the present inventors, according to the embodiment. In FIG. 3, a horizontal axis represents the coupling coefficient κ between the superconducting coil 12 and the secondary coil 32, and a vertical axis represents the energy extraction efficiency η. The relationship between the coupling coefficient κ and the energy extraction efficiency η is calculated for a plurality of values of the time constant ratio τ2/τ1, and these are shown in FIG. 3. Specifically, the relationship is shown for three cases in which the time constant ratio τ2/τ1 is 2, 5, and 10.

As can be understood from FIG. 3, the energy extraction efficiency η monotonically increases as the coupling coefficient κ increases. As described above, in practice, the energy extraction efficiency η by the energy extraction mechanism 30 is desirably at least 0.1. In order to realize this, the coupling coefficient κ is preferably 0.3 or more. In order to realize a larger energy extraction efficiency η, the coupling coefficient κ may be 0.5 or more or 0.7 or more. In addition, in consideration of a dimensional constraint in a case of disposing the superconducting coil 12 and the secondary coil 32 close to each other, the coupling coefficient κ may be, for example, 0.95 or less or 0.9 or less.

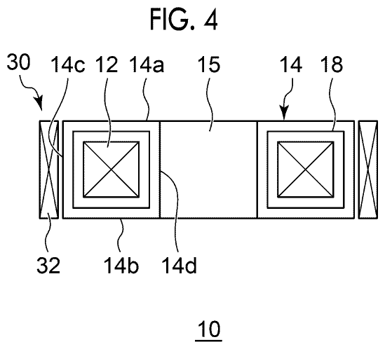

FIG. 4 is a diagram schematically showing the superconducting magnet device 10 according to another embodiment. As shown in FIG. 4, the superconducting magnet device 10 includes the superconducting coil 12, the vacuum vessel 14, the heat shield 18, and the energy extraction mechanism 30. The energy extraction mechanism 30 includes the secondary coil 32. Although not shown in FIG. 4, the superconducting magnet device 10 shown in FIG. 4 may also include the cryocooler 16, the current introduction line 20, the first Joule heat generating element 22, the external power source 24, and the second Joule heat generating element 34, as in the superconducting magnet device 10 described with reference to FIG. 1.

The secondary coil 32 is disposed outside the vacuum vessel 14. In this example, the vacuum vessel 14 has a cylindrical shape having a hollow portion 15 at a center portion thereof. The vacuum vessel 14 has the generally flat annular top plate 14a and the bottom plate 14b and a cylindrical outer peripheral wall 14c and an inner peripheral wall 14d that are coaxially disposed to connect the top plate 14a and the bottom plate 14b. As an example, as shown in FIG. 4, the secondary coil 32 may be disposed outside the vacuum vessel 14 to surround the outer peripheral wall 14c of the vacuum vessel 14.

In a case where the secondary coil 32 is disposed inside the vacuum vessel 14 as in the above-described embodiment, it is considered that a large secondary coil 32 is difficult to adopt in many cases due to a dimensional constraint on the secondary coil 32 caused by a volume of the vacuum vessel 14 and a positional relationship with various other elements inside the vacuum vessel 14. On the other hand, as shown in FIG. 4, in a case where the secondary coil 32 is disposed outside the vacuum vessel 14, it is easier to increase the size of the secondary coil 32 compared to a case where the secondary coil 32 is not disposed outside the vacuum vessel 14. Since the time constant τ2 of the secondary circuit is proportional to a cross-sectional area of the secondary coil 32, the time constant τ2 of the secondary circuit can be increased by increasing a coil height or a coil diameter of the secondary coil 32 to increase the size of the secondary coil 32. The energy can be efficiently extracted from the superconducting coil 12 by the energy extraction mechanism 30.

The secondary coil 32 may be disposed outside the vacuum vessel 14 to be surrounded by the inner peripheral wall 14d of the vacuum vessel 14. The secondary coil 32 may be disposed outside the vacuum vessel 14 adjacent to the top plate 14a or adjacent to the bottom plate 14b of the vacuum vessel 14. Alternatively, a combination of these is also possible. That is, the secondary coil 32 may be provided at a plurality of locations of the top plate 14a, the bottom plate 14b, the outer peripheral wall 14c, and the inner peripheral wall 14d of the vacuum vessel 14.

The energy extraction mechanism 30 may include a plurality of the secondary coils 32, and at least one secondary coil 32 may be disposed inside the vacuum vessel 14 and at least one other secondary coil 32 may be disposed outside the vacuum vessel 14.

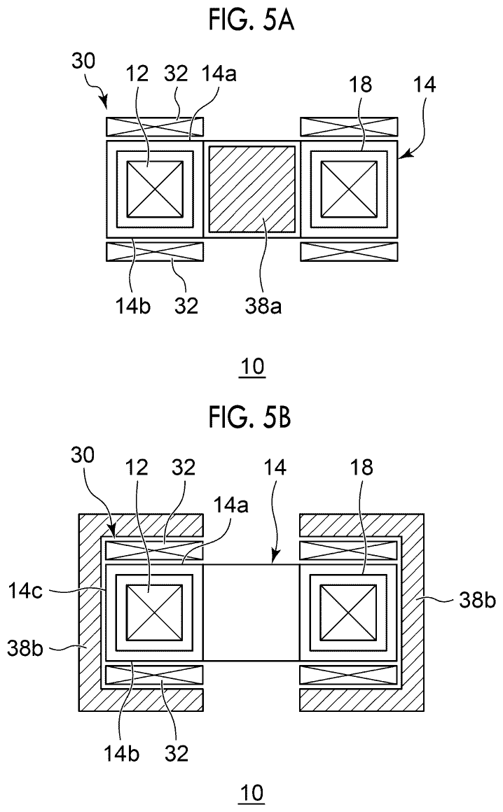

FIGS. 5A and 5B are diagrams schematically showing the superconducting magnet device 10 according to other embodiments. The superconducting magnet device 10 includes the superconducting coil 12, the vacuum vessel 14, the heat shield 18, and the energy extraction mechanism 30 as shown in FIG. 4. The energy extraction mechanism 30 includes the secondary coil 32. In this example, the secondary coil 32 is disposed outside the vacuum vessel 14 adjacent to each of the top plate 14a and the bottom plate 14b of the vacuum vessel 14.

In the superconducting magnet device 10 shown in FIG. 5A, a core 38a is provided in the secondary coil 32. The core 38a is disposed in the hollow portion of the vacuum vessel 14. In addition, in the superconducting magnet device 10 shown in FIG. 5B, a yoke 38b is provided in the secondary coil 32. The yoke 38b is disposed around the superconducting magnet device 10 to be adjacent to both upper and lower sides of the secondary coil 32 and to surround the outer peripheral wall 14c of the vacuum vessel 14. The core 38a or the yoke 38b has an effect of increasing magnetic permeability. Since the time constant τ2 of the secondary circuit is proportional to the permeability, the time constant τ2 of the secondary circuit can be increased. The energy can be efficiently extracted from the superconducting coil 12 by the energy extraction mechanism 30.

In a case of starting up the superconducting magnet device 10, the excitation current is supplied from the external power source 24 to the superconducting coil 12 through the current introduction line 20, and the superconducting coil 12 is excited. During the excitation of the superconducting coil 12, the external power source 24 may increase the excitation current at a predetermined current increase rate (for example, a constant current increase rate) from zero to a rated current value of the superconducting coil 12. After the excitation of the superconducting coil 12 is completed, the external power source 24 may maintain the excitation current at the rated current value. In this way, the superconducting coil 12 can generate a magnetic field in response to the excitation current.

During the excitation of the superconducting coil 12, as the magnetic field generated by the superconducting coil 12 increases from zero to a desired high magnetic field, a current is induced in the secondary coil 32 by electromagnetic induction. This current flows from the secondary coil 32 to the second Joule heat generating element 34 through the electric wiring line 36, causing the second Joule heat generating element 34 to generate heat. In this way, a portion of the energy input for the excitation of the superconducting coil 12 is consumed in the secondary circuit. This leads to an increase in power consumption in exciting the superconducting coil 12, which is not preferable.

When a current flows through the secondary coil 32, the secondary coil 32 also generates a transient magnetic field. Such a non-uniform magnetic field by the secondary coil 32 may have an undesirable effect on the magnetic field of the superconducting coil 12. In a case where the secondary coil 32 includes the superconducting coil, there is also a concern that, because the resistance is small due to superconductivity, the attenuation of the current, and therefore the suppression of the non-uniform magnetic field, may take time.

In a case where the second Joule heat generating element 34 includes a rectifying element such as the second diode 34a, the rectifying element may be connected between both ends of the secondary coil 32 to block a current in a first direction induced in the secondary coil 32 when the magnetic field of the superconducting coil 12 increases and to allow a current in a second direction opposite to the first direction induced in the secondary coil 32 when the magnetic field of the superconducting coil 12 decreases. By connecting the second Joule heat generating element 34 to the secondary coil 32 in such an orientation, the induced current that can flow to the energy extraction mechanism 30 during the excitation of the superconducting coil 12 is blocked. Therefore, the increase in power consumption and the adverse effect of the non-uniform magnetic field as described above can be avoided. On the other hand, in a case where a quench occurs and the superconducting coil 12 is demagnetized, the second Joule heat generating element 34 allows the induced current to flow to the secondary coil 32. Therefore, the energy extraction mechanism 30 can extract the energy during the demagnetization of the superconducting coil 12 and can deal with the above-described problem caused by the occurrence of the quench.

However, from the viewpoint of increasing the time constant τ2 of the secondary circuit for the efficient energy extraction by the energy extraction mechanism 30, it may not be optimal to employ the rectifying element in the second Joule heat generating element 34. This is because the resistance of the rectifying element itself may become relatively large. As described above, since the time constant τ2 is defined by the ratio L2 /R2 of the inductance L2 of the secondary coil 32 to the resistance value R2 of the secondary-side resistor connected to the secondary coil 32, the time constant τ2 may become small in a case where the resistance of the rectifying element is large. In a case where this is to be avoided, the second Joule heat generating element 34 may include a general linear (that is, Ohmic) resistive element instead of the rectifying element such as the diode.

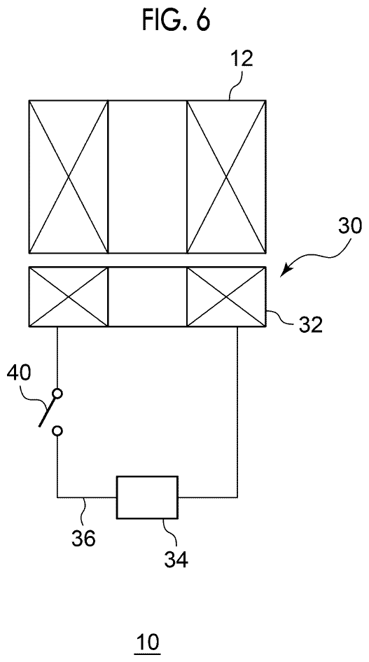

FIG. 6 is a diagram schematically showing another example of the superconducting magnet device 10 according to the embodiment. The superconducting magnet device 10 includes the primary circuit including the superconducting coil 12 and the secondary circuit constituting the energy extraction mechanism 30 as in the above-described embodiment. The energy extraction mechanism 30 includes the secondary coil 32 electromagnetically coupled to the superconducting coil 12 and the secondary-side resistor, for example, the second Joule heat generating element 34 connected to the secondary coil 32. The secondary coil 32 and the second Joule heat generating element 34 are connected by an electric wiring line 36. In addition, the energy extraction mechanism 30 includes a switch 40 that blocks or allows a current flowing through the secondary coil 32, the details of which will be described below.

The energy extraction mechanism 30 shown in FIG. 6 may be applied to the superconducting magnet device 10 described with reference to FIG. 1. Therefore, although not shown, the superconducting magnet device 10 shown in FIG. 6 can also include the vacuum vessel 14, the cryocooler 16, the heat shield 18, the current introduction line 20, the first Joule heat generating element 22, and the external power source 24, as in the superconducting magnet device 10 described with reference to FIG. 1.

The switch 40 is connected in series with the secondary coil 32 and is configured to switch between an OFF state of blocking the current flowing through the secondary coil 32 and an ON state of allowing the current flowing through the secondary coil 32. As shown in FIG. 6, the switch 40 may be provided on the electric wiring line 36 that connects the secondary coil 32 and the second Joule heat generating element 34 to electrically connect or disconnect the secondary coil 32 to or from the second Joule heat generating element 34. In FIG. 6, the switch 40 in the OFF state is shown.

In order to extract the energy more efficiently from the superconducting coil 12, resistance of the switch 40 itself in the ON state is preferably as small as possible and ideally zero in order to cause a larger current to flow through the secondary coil 32. From such a viewpoint, the switch 40 may be a persistent current switch.

A known persistent current switch can be employed as the persistent current switch that can be used as the switch 40. For example, the switch 40 may be a mechanical persistent current switch. Like a typical mechanical switch, the mechanical persistent current switch is in the ON state by mechanically bringing one contact and the other contact into contact with each other, and is in the OFF state by mechanically separating the contacts. In addition, the switch 40 may be a thermal persistent current switch. A typical thermal persistent current switch includes a superconducting wire and a heater that heats the superconducting wire, and is in the ON state in a case where the superconducting wire is in a superconducting state and is in the OFF state in a case where the superconducting wire is heated by the heater and loses its superconductivity.

Alternatively, the switch 40 may be, for example, a general-purpose switch such as a mechanical switch or a semiconductor switch, or any other type of switch that can switch between ON and OFF of the current flowing through the secondary coil 32.

The switch 40 may be configured to be in the OFF state during the excitation of the superconducting coil 12. The switch 40 may be configured to switch from the OFF state to the ON state when the excitation of the superconducting coil 12 is completed or at a predetermined timing after the excitation is completed. The switch 40 may be configured to be in the ON state after the excitation of the superconducting coil 12 is completed.

With such a configuration, during the excitation of the superconducting coil 12, the switch 40 is in the OFF state, and the induced current that may occur in the secondary coil 32 is blocked. Therefore, the energy consumption by the energy extraction mechanism 30 during the excitation of the superconducting coil 12 can be suppressed, and the occurrence of the non-uniform magnetic field by the secondary coil 32 can be prevented. On the other hand, in a case where a quench occurs and the superconducting coil 12 is demagnetized, the switch 40 enters the ON state, and the current can flow through the secondary coil 32. The energy extraction mechanism 30 can extract the energy during the demagnetization of the superconducting coil 12 and can deal with the above-described problem caused by the occurrence of the quench.

The energy extraction mechanism 30 shown in FIG. 6 may be applied to the superconducting magnet device 10 described with reference to FIG. 4, FIG. 5A, or FIG. 5B.

the present invention has been described hereinbefore based on the examples. It will be understood by those skilled in the art that the present invention is not limited to the above-described embodiment, various design changes are possible, various modification examples are possible, and such modification examples are also within the scope of the present invention. Various features described in relation to a certain embodiment are also applicable to other embodiments. A new embodiment generated through combination also has the effects of each of the combined embodiments.

In the above-described embodiment, a case where the cryocooler 16 is a GM cryocooler has been described as an example. However, the present invention is not limited thereto. In a certain embodiment, the cryocooler 16 may be another type of two-stage cryocooler having the first cooling stage 16a and the second cooling stage 16b, such as a Solvay cryocooler, a Stirling cryocooler, or a pulse tube cryocooler.

In FIG. 1, as an example, one cryocooler 16 is shown. However, as necessary, for example, as in a case where the superconducting coil 12 is large, the superconducting magnet device 10 may include a plurality of cryocoolers 16 that cool one superconducting coil 12.

In the above-described embodiment, the superconducting magnet device 10 is configured as a so-called conduction-cooled type in which the superconducting coil 12 is directly cooled by the cryocooler 16, instead of an immersion-cooled type in which the superconducting coil 12 is immersed in a cryogenic liquid refrigerant such as liquid helium. However, the superconducting magnet device 10 may be of an immersion-cooled type. In this case, the superconducting coil 12 may be immersed in and cooled by a cryogenic liquid such as liquid helium, and at least one of the first Joule heat generating element 22 and the energy extraction mechanism 30 may be cooled by using a refrigerant having a higher boiling point (for example, liquid nitrogen or the like) than the cryogenic liquid. In this way, the first Joule heat generating element 22 may be cooled to a higher cooling temperature than the superconducting coil 12 during the operation of the superconducting coil 12. Alternatively, at least one of the first Joule heat generating element 22 and the energy extraction mechanism 30 may be cooled by liquid helium as in the superconducting coil 12.

The superconducting magnet device 10 may include a plurality of the superconducting coils 12, and in this case, each superconducting coil 12 may be provided with the first Joule heat generating element 22 connected in parallel to the superconducting coil 12. In addition, the superconducting magnet device 10 may include a plurality of the energy extraction mechanisms 30, and in this case, the energy extraction mechanism 30 corresponding to each superconducting coil 12 may be provided.

Although the present invention has been described using specific phrases based on the embodiment, the embodiment merely shows one aspect of the principles and applications of the present invention, and many modification examples and changes in disposition are allowed without departing from the concept of the present invention specified in the claims.

The present invention can be used in the field of superconducting magnet devices.

It should be understood that the invention is not limited to the above-described embodiment, but may be modified into various forms on the basis of the spirit of the disclosure. Additionally, the modifications are included in the scope of the disclosure.

What is claimed is:

1. A superconducting magnet device comprising:
a primary circuit including a superconducting coil and a primary-side resistor connected to the superconducting coil; and
a secondary circuit including a secondary coil electromagnetically coupled to the superconducting coil and a secondary-side resistor connected to the secondary coil,
wherein a time constant of the secondary circuit is equal to or more than a time constant of the primary circuit.

2. The superconducting magnet device according to claim 1, further comprising:
a cryocooler configured to cool the secondary coil to a first cooling temperature and to cool the superconducting coil to a second cooling temperature lower than the first cooling temperature.

3. The superconducting magnet device according to claim 2, wherein the secondary coil includes a high-temperature superconducting coil.

4. The superconducting magnet device according to claim 1, further comprising:
a vacuum vessel that accommodates the superconducting coil,
wherein the secondary coil is disposed outside the vacuum vessel.

5. The superconducting magnet device according to claim 4, further comprising:
a heat shield disposed to surround the superconducting coil within the vacuum vessel; and
a current introduction line that forms a current path from an external power source to the superconducting coil.

6. The superconducting magnet device according to claim 5,
wherein the heat shield is directly attached to a first cooling stage of a cryocooler and thermally coupled to the first cooling stage.

7. The superconducting magnet device according to claim 5,
wherein the current introduction line includes a feedthrough that is a hermetically sealed terminal for introducing current into the vacuum vessel, and the current introduction line penetrates a wall portion of the vacuum vessel while maintaining airtightness of the vacuum vessel using the feedthrough.

8. The superconducting magnet device according to claim 1, wherein a core or a yoke is provided in the secondary coil.

9. The superconducting magnet device according to claim 8,
wherein the core is disposed in a hollow portion of a vacuum vessel, and
the yoke is disposed adjacent to both upper and lower sides of the secondary coil and around the superconducting magnet device so as to surround an outer peripheral wall of the vacuum vessel.

10. The superconducting magnet device according to claim 1,
wherein a coupling coefficient between the superconducting coil and the secondary coil is 0.3 or more.

11. The superconducting magnet device according to claim 1,
wherein the secondary circuit includes a switch that blocks or allows a current flowing through the secondary coil.

12. The superconducting magnet device according to claim 11,
wherein the switch is configured to be in an OFF state during excitation of the superconducting coil and to be in an ON state after the excitation of the superconducting coil is completed.
